(19) United States
(12) Patent Application Publication
(10) Pub. No.: US 2008/0063768 A1
(43) Pub. Date: Mar. 13, 2008

(54) QUICK CHILLING OF FRY OIL UNDER MODIFIED ATMOSPHERE

(76) Inventors: Vasuhi Rasanayagam, Chicago, IL (US); Edward F. Steiner, Downers Grove, IL (US); James T.C. Yuan, Yorktown Heights, NY (US)

Correspondence Address: AIR LIQUIDE INTELLECTUAL PROPERTY DEPT., 2700 POST OAK BLVD., SUITE 1800, HOUSTON, TX, 77056, US

(21) Appl. No.: 11/778,144

(22) Filed: Jul. 16, 2007

Related U.S. Application Data
(60) Provisional application No. 60/843,614, filed on Sep. 11, 2006.

(51) Int. Cl. C11B 3/02; A47J 37/12

(52) U.S. Cl. 426/417; 99/330; 99/355

(57) ABSTRACT

Systems and methods improve the useful life of fry oil by inhibiting or eliminating factors that degrade the oil. A flow of gas in contact with the oil provides efficient cooling of the oil that was heated but is for a temporary period of time not needed to be kept hot. Further, utilizing inert gas for the cooling provides protection of the oil from oxidation. For example, chilled or liquid nitrogen gas introduced into a head space above an oil surface and/or into the oil both cools the oil and protects the oil from oxidation.

### CROSS-REFERENCE TO RELATED APPLICATIONS

This application claims the benefit under 35 U.S.C. §119(e) to provisional application No. 60/843,614, filed Sep. 11, 2006, the entire contents of which are incorporated herein by reference.

### BACKGROUND

A food fryer, such as an industrial scale continuous fryer for making potato chips, utilizes oil that is heated for frying processes. Oxidation and heat of the oil contribute to deterioration or damage to the oil and necessitate periodic changing out of the oil in the fryer. Replacing degraded oil with fresh oil maintains quality of products being fried but adds additional cost and down time with every required replacement.

During interruptions in the frying process or shut down operations, the oil retains for some time heat that is not needed while frying is stopped. The oil that was heated cools down by natural convection. To speed up cooling of the oil at times between the frying processes and hence aid in prolonging useful life of the oil, some systems remove the oil from the fryer and pass the oil through a plate type heat exchanger fed with water for facilitating transference of the heat from the oil. However, such systems require removal of the oil from the fryer and additional equipment that lacks efficiency for rapid cooling of the oil.

Regarding oxidation, oxygen in the atmosphere reacts with the oil. Therefore, some processes introduce nitrogen gas to displace the oxygen and water vapor to help avoid oxidation. For example, nitrogen blanketing assures absence of oxygen in holding tanks for the oil. Past uses of nitrogen to avoid oxidation fail to address degradation caused by the heat of the oil.

Therefore, a need exists for methods and apparatus for mitigating degradation of fry oil.

### SUMMARY

One embodiment provides a food frying system that includes a fryer having a kettle covered by a hood. A fluid outlet is disposed in a head space under the hood. In addition, a chilled gas source is in fluid connection with the outlet.

Another embodiment provides a method of cooling fry oil. The method includes introducing chilled gas into a head space of a fryer. The temperature of the chilled gas may be below 0° C.

For one embodiment, a method of operating a food frying system includes heating fry oil in a fryer. Subsequent to the heating, stopping the heating of the oil occurs for a period of time, such as a duration between frying procedures. Cooling the oil takes place while the heating is stopped and the oil remains in the fryer. The cooling may include introducing chilled nitrogen (N₂) into the fryer.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 illustrates a front partial section view of a system with a fryer and a chilled fluid supply for cooling oil in the fryer, according to one embodiment of the invention;

FIG. 2 illustrates a side view of the fryer;

FIG. 3 illustrates a top view of the fryer;

FIG. 4 illustrates a front partial section view of an assembly to introduce gas into oil for chilling the oil between frying operations, according to one embodiment of the invention;

FIG. 5 illustrates a front partial section view of a food frying apparatus with baffles disposed adjacent an outlet for chilled fluid, according to one embodiment of the invention;

FIG. 6 illustrates a flow chart for a method of chilling fry oil, according to one embodiment of the invention.

### DESCRIPTION OF PREFERRED EMBODIMENTS

Embodiments of the invention relate to improving useful life of fry oil by inhibiting or eliminating factors that degrade the oil. Systems and methods utilize a flow of gas in contact with the oil to provide efficient cooling of the oil that was heated but is for a temporary period of time not needed to be kept hot. Further, utilizing inert gas for the cooling provides protection of the oil from oxidation. For example, chilled or liquid nitrogen gas introduced into a head space above an oil surface and/or into the oil both cools the oil and protects the oil from oxidation.

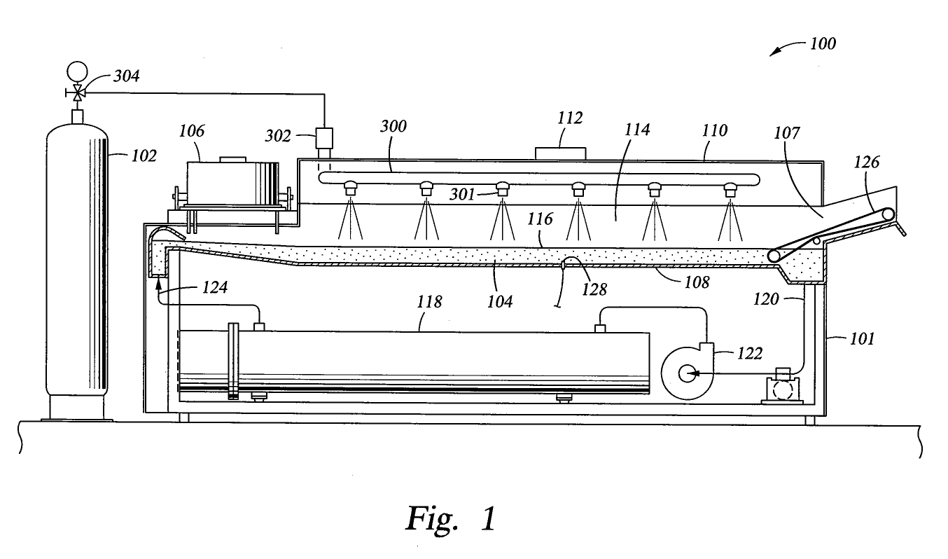

FIG. 1 illustrates a system with a food fryer 100 and a chilled fluid supply 102 for cooling oil 104 in the fryer 100. The chilled fluid supply 102 and accompanying arrangement for cooling the oil 104 as described herein may be utilized with any frying system exemplified by the fryer 100, which depicts only one representative configuration for the purpose of explanation. The fryer 100 includes a housing 101 with an entry port 106 for loading food into the oil 104 and an exit port 107 to deliver cooked food from the fryer 100. A kettle 108 within the fryer 100 extends between the entry and exit ports 106, 107 and contains the oil 104. Further, a hood 110 of the fryer 100 covers a length of the kettle 108 and includes a vent 112 equipped with a blower for exhausting an atmosphere in a head space 114 above the oil 104 such as defined between a surface 116 of the oil 104 and an inside of the hood 110.

The fryer 100 additionally includes a heat exchanger 118. The heat exchanger 118 heats the oil 104 taken from an outlet line 120 disposed in communication with the oil 104 in the kettle 108 proximate the exit port 107 of the fryer 100. A pump 122 that is coupled to the heat exchanger 118 urges the oil 104 through the heat exchanger 118 and then back to the kettle 108 proximate the entry port 106 via an inlet line 124. This circulation of the oil 104 causes the oil 104 to flow along the length of the kettle 108.

In a frying process or operation, the food is introduced into the entry port 106 and travels within the oil 104 along the length of the kettle 108 toward the exit port 107, thereby cooking the food in the oil 104 heated by the heat exchanger 118. At the exit port 107, a delivery conveyor 126 removes the cooked food from the oil 104 and out of the fryer 100 to a hopper, for example. Turning off the heat exchanger 118 during intervals (hereinafter “interruptions”) in between each frying process stops any unnecessary heating of the oil 104. During the interruptions, gas flow facilitates cooling of the oil 104 as described further herein.

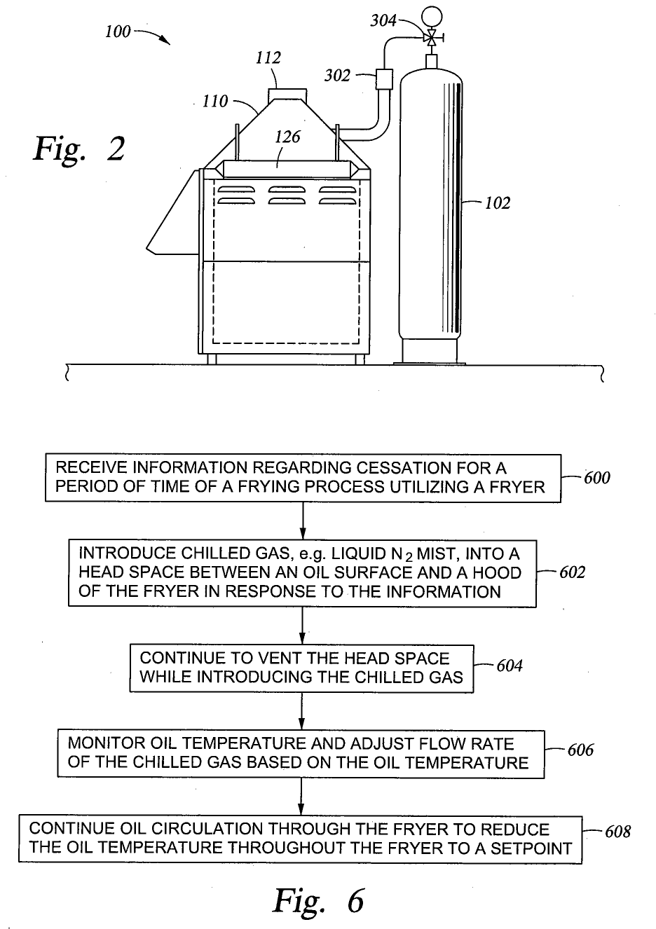

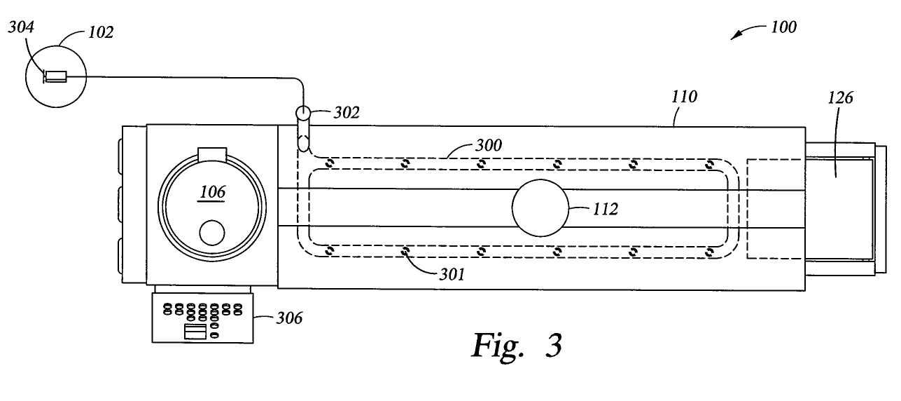

FIGS. 2 and 3 respectively show a side view and a top view of the fryer 100. In order to provide the gas flow to cool the oil 104, the fryer 100 includes a manifold 300 with one or more nozzles 301 directed into the head space 114. A fluid input 302 couples the manifold 300 with the chilled fluid supply 102. The interruption not only stops heating of the oil 104 but also introduces flow from the chilled fluid supply 102, which is chilled to a temperature selected to cool the oil 104 by the gas flow in contact with the surface 116 of the oil 104. In some embodiments, the nozzles 301 may be disposed 0.3 meters or less above the surface 116 of the oil 104. The temperature of gas or gasses from the chilled fluid supply 102 may be at or below a target temperature or setpoint for the oil 104 during the interruption. For some embodiments the chilled fluid supply 102 includes liquefied gas or gasses, such as liquid nitrogen (N₂) below for example −196° C.

In some embodiments, the chilled fluid supply 102 includes chilled gas, including liquefied gas. The chilled gas may comprise one or more of nitrogen, argon and helium, for example. Further, the chilled gas may be below 0° C., below −50° C., below −100° C., below −150° C. at exit from the nozzles 301. Content of the chilled fluid supply 102 for some embodiments is selected to displace oxygen in the head space 114. For example, the chilled fluid supply 102 may be devoid of oxygen (O₂) or carbon dioxide (CO₂) to help limit oxidation of the oil 104.

The oil 104 fills a relatively small depth in the kettle 108 compared to width and length of the surface 116 of the oil 104. A surface to volume ratio of the oil 104 thereby enables the gas flow to be effective in cooling the oil 104. For example, the ratio may be from about 1:7 to about 1:8. In an oil cooling operation of one embodiment, liquid nitrogen is sprayed as a gas and/or mist through the nozzles 301 creating cold nitrogen gas that further absorbs heat energy from the oil 104 in addition to heat required from the oil 104 for the vaporization of the liquid nitrogen. The nitrogen gas may come in contact with the oil 104 or come in close enough proximity to the oil 104 to absorb heat of the oil 104. During the cooling operation, the vent 112 draws warmed nitrogen gas out of the head space 114 for refreshing with cooler nitrogen gas. Use of the vent 112 imparts flow through the head space 114 of the nitrogen gas even with as few as one of the nozzles 301, which are shown spaced around the hood 110 at multiple locations. Evacuating the nitrogen gas introduced from the chilled fluid supply 102 prevents a room housing the fryer 100 from becoming unsafe due to overfilling of the room with the nitrogen gas. Further, the pump 122 circulates the oil 104 across the kettle 108 to ensure that all the oil 104 in the fryer 100 is cooled. Introduction and evacuation of the nitrogen gas may occur simultaneously through the cooling cycle. Further, different and/or varying flow rates may exist for introduction and evacuation of the nitrogen gas.

For some embodiments, control of the fryer 100 may be automated. A temperature probe 128 (shown in FIG. 1) disposed in the oil 104 measures temperature of the oil 104 for input into a controller 306, which may have a display to output the temperature. The controller 306 functions the heat exchanger 118 and regulates flow through a valve 304 coupled to the chilled fluid supply 102. Flow rate of the gas flow from the chilled fluid supply 102 may depend in a feedback relationship on the temperature of the oil 104 sensed by the controller 306 that increases the flow rate for higher oil temperatures and decreases the flow rate for lower oil temperatures. Such flow control brings the temperature of the oil 104 down as soon as possible..

The controller 306 may regulate in a respective manner other operations, such as flow through the vent 112 and circulation of the oil 104 using the pump 122. For example, the controller 306 may stop the pump 122 upon reaching an identified minimum temperature for the oil 104 and may adjust the vent 112 depending on flow through the valve 304. In some embodiments, the controller 306 may send appropriate actuation signals, based on temperature settings for the oil 104, to alternatively transfer between heating the oil 104 with the heat exchanger 118 and cooling the oil 104 utilizing the chilled fluid supply 102 as manipulated with the valve 304.

Starting the fryer 100 or at least activating the heat exchanger 118 such as occurs when an operator sets the controller 306 to preheat the oil 104 for frying, closes the valve 304, maintains the valve 304 closed, or reduces flow from the chilled fluid supply 102 through the valve 304. The operator may later in time shut down the fryer 100 or otherwise stop heating of the oil 104 by adjusting settings at the controller 306, thereby creating the interruption described heretofore. Upon receiving a command associated with the interruption, the controller 306 deactivates the heat exchanger 118 and increases flow from the chilled fluid supply 102.

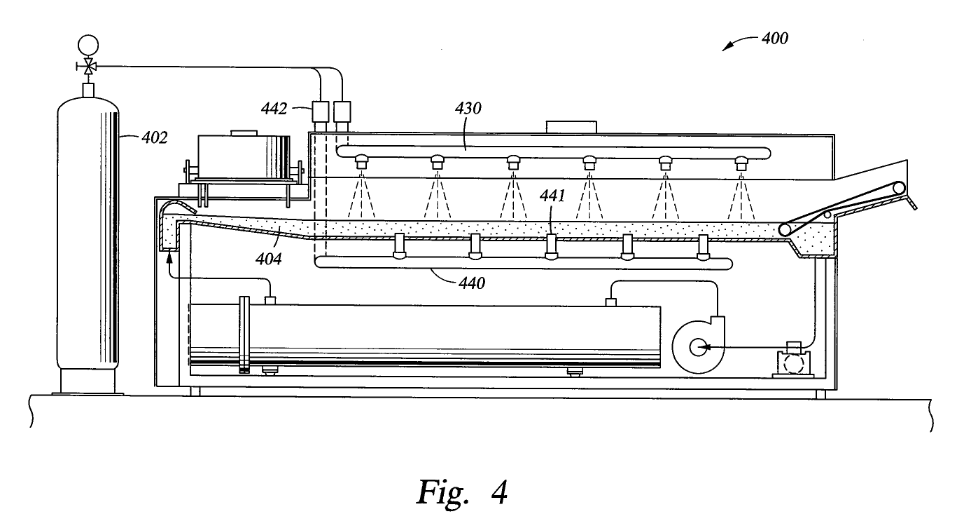

FIG. 4 illustrates a front partial section view of an assembly 400 to introduce gas into oil 404 for chilling the oil 404 between frying operations. The assembly 400 operates similar to the fryer 100 described above so that like components and functions are not repeated for conciseness. The assembly 400 includes a source 402 of chilled gas in fluid connection with a gas inlet 442. The gas inlet 442 couples to a distributor 440 having a plurality of spargers 441 disposed in the oil 404. The source 402 may include any inert gas such as those of the chilled fluid supply 102. Location of the spargers 441 may be anywhere in a flow path of the oil 404 (e.g., along a kettle, in lines or conduits, or within holding tanks) without being limited to an exemplary position shown in FIG. 4. For some embodiments, the assembly 400 further includes a chilled gas shower 430 that is disposed above the oil 404, is optional and may aid cooling as described above regarding FIGS. 1-3

Air bubbles from the spargers 441 and at a lower temperature than the oil 404 cause cooling of the oil 404 as the bubbles pass through the oil 404. Once the bubbles escape the chilled gas fills the atmosphere above the oil 404 as described herein. Therefore, flow from the source 402 through the spargers 441 may be controlled and used to prolong useful life of the oil 404 analogous to any automation and cooling methods described herein.

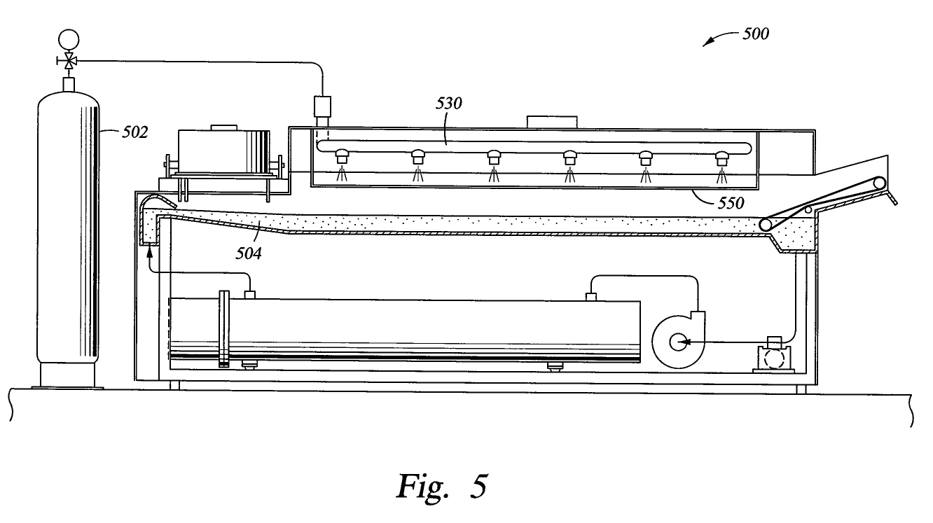

FIG. 5 shows a food frying apparatus 500, for some embodiments, that again operates similar to the fryer 100 described above so that like components and functions are not repeated for conciseness. The apparatus 500 includes a chilled gas shower 530 that introduces gas and/or liquefied gas for chilling fry oil 504 between frying operations. The apparatus 500 includes a source 502 of chilled gas in fluid connection with the shower 530. The source 502 may include any inert gas such as those of the chilled fluid supply 102. Nozzles or outlets of the shower 530 may be directed in any one or more directions without necessarily pointing toward the oil 504.

Further, the apparatus 500 includes baffles 550 between a surface of the oil 504 and the shower 530. The baffles 550 define a generally horizontal, suspended, plate that may impede or block any falling liquid form of the gasses expelled through the shower 530 from contacting the oil 504. Since the baffles 550 do not provide an enclosure for the shower 530, cold gas fills a head space as previously described herein in order to chill the oil 504 upon vaporization of the liquid form of the gasses after contacting the baffles 550, which may be made of metal.

FIG. 6 shows a flow chart for a method of chilling fry oil. Shut down step 600 includes receiving information regarding cessation for a period of time of a frying process utilizing a fryer. An operator may initiate the shut down step 600. In response to the information, introducing chilled gas into a head space between an oil surface and a hood of the fryer occurs in active oil cooling step 602. The chilled gas introduced in the cooling step 602 includes a gas or mist from a liquid nitrogen source. Through the cooling step 602, a venting step 604 continues to exhaust an atmosphere in the head space to enable refreshing of the chilled gas.

Monitoring step 606 includes sensing oil temperature and adjusting flow rate of the chilled gas based on the oil temperature. During the cooling step 602, oil continues to circulate through the fryer to reduce the oil temperature throughout the fryer to a setpoint, as indicated in oil circulation step 608. Once the set point is reached, the atmosphere in the head space may be maintained with oxygen displacing gas that may not be chilled. The oil may be kept in the fryer at all times ready for restarting of the fryer. The restarting of the fryer may then reheat the oil until which time the method is repeated.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A food frying system, comprising:
a fryer having a kettle covered by a hood;
a fluid outlet disposed in a head space contained within the hood covering the kettle; and
a chilled gas source in fluid connection with the outlet, wherein a temperature of a chilled gas from the chilled gas source at the outlet is selected to effect a cooling of fry oil contained in the fryer sufficient to extend a useful life of the fry oil.

2. The system of claim 1, wherein the chilled gas source comprises liquid nitrogen.

3. The system of claim 1, further comprising a baffle disposed within a flow path of liquid falling from the fluid outlet toward the fry oil contained in the fryer.

4. The system of claim 1, wherein the chilled gas source is below 0° C.

5. The system of claim 1, further comprising a controller configured to operate a flow control device between the source and the outlet.

6. The system of claim 5, wherein the controller adjusts the flow control device based on temperature of the fry oil.

7. The system of claim 5, wherein the controller automatically opens the flow control device upon interruption in fry oil heating.

8. A method of cooling fry oil, comprising:
introducing chilled gas into a head space of a food fryer containing the fry oil, wherein temperature of the chilled gas is below 0° C. and wherein the chilled gas in the head space is brought into proximity with the fry oil to effect heat exchange between the fry oil and the chilled gas sufficient to extend a useful life of the fry oil.

9. The method of claim 8, wherein the introducing includes injecting a liquefied form of the chilled gas onto a baffle disposed in the head space.

10. The method of claim 8, wherein the introducing includes injecting the gas into the fry oil in the fryer.

11. The method of claim 8, wherein the introducing includes injecting the gas via a nozzle disposed in the head space.

12. The method of claim 11, wherein the injecting emits liquid nitrogen from the nozzle.

13. The method of claim 8, wherein the introducing includes injecting the gas into the fry oil in the fryer and via a nozzle disposed in the head space.

14. The method of claim 8, further comprising heating the fry oil and interrupting the heating prior to initial introduction of the chilled gas.

15. The method of claim 8, further comprising circulating the fry oil while introducing the chilled gas without heating the fry oil.

16. The method of claim 8, further comprising venting an atmosphere in the head space while introducing the chilled gas.

17. A method of operating a food frying system, comprising:
heating fry oil in a fryer;
stopping the heating of the fry oil; and
cooling the fry oil while the heating is stopped and the fry oil remains in the fryer, wherein the cooling includes introducing chilled nitrogen (N₂) into the fryer and into contact with the fry oil to effect heat exchange between the fry oil and the chilled nitrogen sufficient to extend a useful life of the fry oil.

18. The method of claim 17, wherein the cooling further comprises circulating the fry oil.

19. The method of claim 17, wherein the stopping of the heating triggers initiation of the cooling.

20. The method of claim 17, further comprising monitoring the temperature of the fry oil during the cooling and adjusting flow rate of the chilled nitrogen based on the temperature.

21. The method of claim 17, further comprising exhausting warmed nitrogen from the fryer during the cooling.

22. The method of claim 17, wherein the introducing of the chilled nitrogen emits liquid nitrogen from a nozzle disposed above the fry oil.
